(19) United States
(12) Patent Application Publication
(10) Pub. No.: US 2016/0147433 A1
(43) Pub. Date: May 26, 2016

(54) REFERENCE COMMAND STORAGE AND PATTERN RECOGNITION FOR USER INTERFACE IMPROVEMENT

(71) Applicant: General Electric Company, Schenectady, NY (US)

(72) Inventors: Jeng-Weei Lin, Danville, CA (US); Sundar Murugappan, San Ramon, CA (US); Jeong Eon Kim, Danville, CA (US); Arnold Lund, Oakland, CA (US); Veeraraghavan Ramaswamy, San Ramon, CA (US); Chih-Sung Wu, Dublin, CA (US)

(21) Appl. No.: 14/555,333

(22) Filed: Nov. 26, 2014

(51) Int. Cl. G06F 3/0488; G06F 3/0482; G06F 11/30

(52) U.S. Cl. CPC G06F 3/04883; G06F 11/3096; G06F 3/0482

(57) ABSTRACT

A method and system for improving user interface efficiency through muscle memory and a radial menu are disclosed. A computer device stores a list of reference commands. The computer device receives a first input component from a user. The computer device then determines whether the first input component matches a first component of at least one reference command in the list of reference commands. In accordance with a determination that the first input component matches the first component of the at least one reference command in the list of reference commands, the computer device continues to monitor user input without displaying a radial menu. In accordance with a determination that the first input component does not match the first component of the at least one reference command in the list of reference commands, the computer device displays the radial menu to the user.

### TECHNICAL FIELD

The disclosed embodiments relate generally to the field of electronic devices, and in particular to user interfaces for electronic devices.

### BACKGROUND

A graphical user interface (GUI) of a computer application often provides numerous menu options for a user to interact with the computer application and invoke commands. A user typically accesses a menu option by providing a user input at the menu option via a user input device (e.g., a mouse, a touchpad, a touch screen, a spatial operating interface, and so on). An example of a traditional menu is a linear menu that provides a sequential selection of menu options. Typically, a linear menu is arranged in a hierarchical tree and displayed at the top of a GUI. For example, a user moves a cursor to a top-level menu item of the linear menu and selects the menu item to invoke a command or to display a submenu with additional selections that include command options or further submenus. The user may select successive submenu items to invoke a command.

Another example of a traditional menu is a ribbon menu where a set of toolbars are placed on tabs in a tab-bar, typically displayed along the top of a GUI. A user selects an option on the ribbon menu to invoke a command or to display a set of additional options, typically represented by icons, along the width of the application and below the top-level set of options. However, the positions of these traditional menus are generally fixed and require the user to move the cursor across a particular distance to a position within the menu to access menu selections.

The long hierarchical structure of these traditional menus creates a number of problems. These include: A portion of the menu may disappear from the GUI view due to space constraints; a user has to provide a user input via a user input device multiple times (e.g., multiple cursor clicks and touch taps) to reach a desired command on the menu, thus decreasing the operational efficiency of the user; it is difficult for a user to remember a location of a command that resides somewhere in the hierarchy of the menu, and thus the user requires time to locate the command; the menu is at a fixed location, and therefore a user has to move the cursor a considerable distance to access the menu from the user's specified location on the GUI. Because of these problems, users may distribute their limited cognitive resources and attention to the navigation and searching of targeted functions rather than on using the targeted functions for specific tasks. The above problems are amplified when users work on image-heavy applications where the users continuously switch between various functions to interact with or alter images across multiple user interfaces.

### DESCRIPTION OF THE DRAWINGS

Some embodiments are illustrated by way of example and not limitation in the FIGS. of the accompanying drawings, in which:

FIG. 1 is a network diagram depicting a computer device, in accordance with an example embodiment, that includes various functional components.

FIG. 2 is a block diagram illustrating a computer device, in accordance with an example embodiment.

FIGS. 3A-3D are diagrams of a radial menu, in accordance with an example embodiment, and the operation thereof.

FIGS. 4A-4C are diagrams of multi-component commands, in accordance with an example embodiment.

FIGS. 5A-5F are diagrams showing each component of a multi-component command, in accordance with an example embodiment.

FIG. 6 is a flow diagram illustrating a method, in accordance with an example embodiment, for enhancing operational.

FIGS. 7A and 7B are flow diagrams illustrating a method, in accordance with an example embodiment, for enhancing operational efficiency.

FIG. 8 is a block diagram illustrating architecture of software, in accordance with an example embodiment, which may be installed on any one or more devices.

FIG. 9 is a block diagram illustrating components of a machine, in accordance with an example embodiment.

Like reference numerals refer to corresponding parts throughout the drawings.

### DETAILED DESCRIPTION

The present disclosure describes methods, systems, and computer program products for enhancing operational efficiency through development of muscle memory and spatial cognition. In the following description, for purposes of explanation, numerous specific details are set forth to provide a thorough understanding of the various aspects of different embodiments. It will be evident, however, to one skilled in the art, that the any particular embodiment may be practiced without all of the specific details and/or with variations permutations and combinations of the various features and elements described herein.

A system for enhancing operational efficiency through development of muscle memory and spatial cognition is disclosed. Radial menus are used to develop a user's familiarity with the actions that need to be taken to cause a particular action to occur on a computer device. First, the radial menu acts as a visual guide, updating its appearance as the user navigates through the wedges of the menu. However, as a user repeats certain frequently used commands, the speed and accuracy with which the user can navigate the radial menu to a desired menu item or icon increases. As such, the need for the visual guide may be decreased. The computer device can detect when the user become sufficiently familiar with the actions needed to activate a certain command, and may not display the radial menu if it determines that the user is entering the actions needed to activate that command. However, if the user makes an unexpected action or pauses for too long, the computer device can then redisplay the radial menu for ease of use. In this way the user may learn to use certain actions quickly and efficiently without the need for the radial menu.

A radial menu works such that in response to an initiation input (e.g., a tap gesture) the initial section of the radial menu is displayed. For example, the initial display includes a center circle and two or more options displayed around the center circle as a series of wedges. The user then indicates one of the two or more options. The computer device will monitor the user input to identify user selection of one of the two or more options. In response, the user interface is updated to include an additional set of menu items based on the selected wedge. For example, if the user selects the “Edit” wedge of the radial menu, the radial menu is updated to display four additional menu items including “Copy,” “Paste,” “Cut,” and “Select All.” The additional options are displayed such that they are positioned near or adjacent to the wedge with which they are associated.

Thus, selecting specific actions or commands involves navigating multiple layers of a radial menu. A respective command (or action) will always appear in the same position of the default radial menu, and thus the specific input (e.g., series of finger gestures) used to access the respective command may remain constant. Over time, users will begin to internalize the specific input needed to access commonly used commands (e.g., a specific sequence of swipe gestures). Once the computer device determines that the user has become sufficiently familiar with the input needed for a particular command, the computer device adds that command to a list of reference commands, for example, commands that are well-known to a specific user. For example, if the computer device determines that the user is able to complete the specific user input for a particular command without waiting for the radial menu to visually update, the computer device determines that the user input is well known to the user and adds the command to the list of reference commands. In other examples, the computer device determines that an action is well known based on the average number of times a day the user performs the user input to the command.

Once a command is on the list of reference commands, the computer device does not need to display the radial menu as the user performs the user input associated with the command. Thus, when a user begins entering a user input (e.g., a gesture), the computer device compares each component of the user input (e.g., each component of a multi-component gesture) to the input components associated with the reference commands. For example, if a reference command has an associated input with three components (e.g., down, right, up), the computer device then determines whether the first component for an input is down. If the first received component does not match the first component of the reference command, the computer device is able to determine that the input does not match the input for the reference command.

If the first received component does match the first component of the reference command, the computer device then continues to monitor further input components. As each input component is received, the computer device compares it to the next component in the reference command input component list.

In accordance with a determination that any input component does not match the related input component of a reference command, the computer device then displays the appropriate radial menu. However, in accordance with a determination that the current series of input components fully matches an input for a particular reference command, the computer device does not display a radial menu to the user.

In some example embodiments, the computer devices stores one or more gesture macros, wherein a gesture macro is a simple gesture that is well-known to the user that is attached to a more complicated gesture or command. The user can then enter the simpler gesture macro to activate the more complicated gesture or series of gestures.

In some example embodiments, the computer device, when detecting a user input one or more components of a reference command, displays a likely pattern for the reference command (e.g., a visually gesture path on a touch screen). In some example embodiments, this pattern would only be displayed when learning a new command and would eventually not be needed.

In some example embodiments, the computer device has the technology to recognize brain patterns as input (e.g., a head mounted sensor device). The computer device then senses neural activity to detect components of a multi-component command.

In some example embodiments, the computer device could enable a user to validate the user's identity through a reference command. For example, the user specific validation command (e.g., similar to a gesture password) has a specific combination of speed, motion, size, and so on that the user uses to log into the computer device.

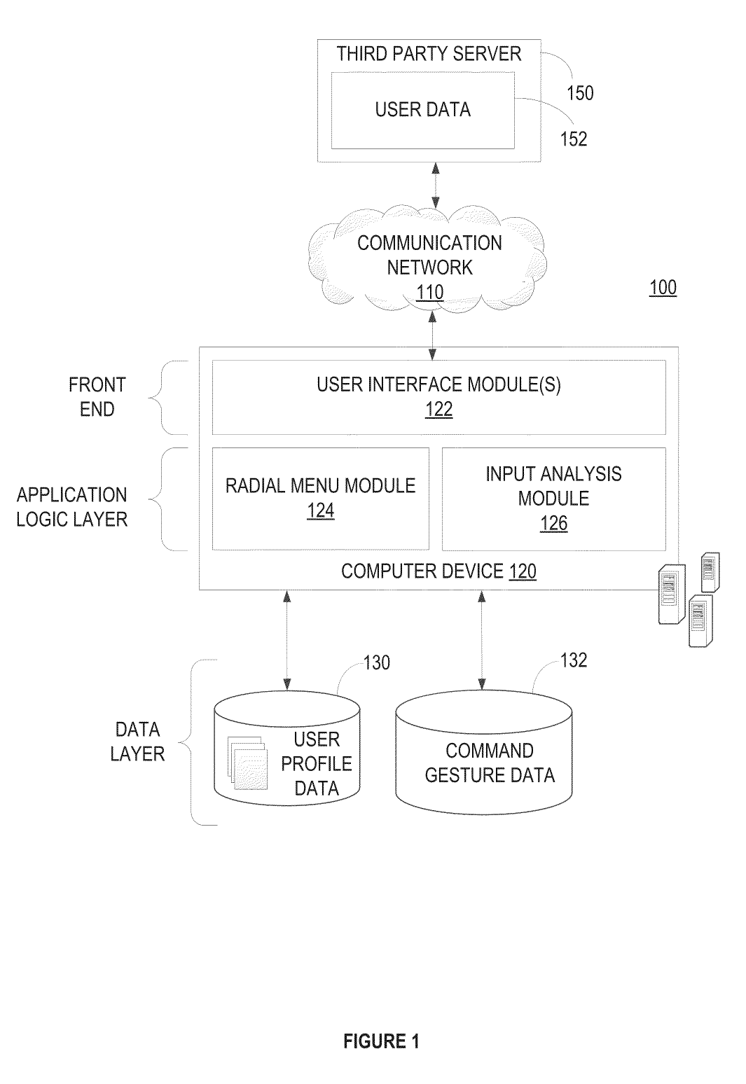

FIG. 1 is a network diagram depicting a computer device, in accordance with an example embodiment, 120 that includes various functional components. In some example embodiments, the computer device 120 is part of a client-server system 100 that includes the computer device 120 and one or more third party servers 150. One or more communications networks 110 interconnect these components. The communications network 110 may be any of a variety of network types, including local area networks (LANs), wide area networks (WANs), wireless networks, wired networks, the Internet, personal area networks (PANs), or a combination of such networks.

In some embodiments, as shown in FIG. 1, the computer device 120 is generally based on a three-tiered architecture, consisting of a front-end layer, an application logic layer, and a data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various embodiments have been omitted from FIG. 1. However, a skilled artisan will readily recognize that various additional functional modules and engines may be used with a computer device 120, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although the computer device 120 is depicted in FIG. 1 as having a three-tiered architecture, the various embodiments are by no means limited to this architecture.

As shown in FIG. 1, the front-end layer consists of a user interface module (e.g., a touch screen) 122, which receives input from a user through one or more input systems (e.g., keyboard, mouse, touch screen, microphone), and presents the appropriate responses on one or more output systems (e.g., screen, speakers, and so on).

As shown in FIG. 1, the data layer includes one or more databases, including databases for storing data for users of the computer device 120, including user profile data 130 and command gesture data 132 (e.g., data listing the gestures that are well known to the user of the computer device 120).

In some embodiments, the user profile data 130 includes data associated with the user, including but not limited to user name, user age, user location, user activity data (e.g., applications and commands used by the user), and other data related to and obtained from the user.

The command gesture data 132 includes data related to the radial menu and the gestures associated with a plurality of commands that may be executed by the computer device 120. The command gesture data 132 also includes one or more reference commands, wherein a reference command is a command that the user is sufficiently familiar with that the user can execute the gesture associated with the command without needing the radial menu to be displayed (e.g., it is well-known to the user).

The computer device 120 provides a broad range of other applications and services that allow users the opportunity to share and receive information, often customized to the interests of the users.

In some embodiments, the application logic layer includes various application server modules, which, in conjunction with the user interface module(s) 122, generate various user interfaces to receive input from and deliver output to a user. In some embodiments, individual application modules are used to implement the functionality associated with various applications, services, and features of the computer device 120. For instance, a messaging application, such as an email application, an instant messaging application, or some hybrid or variation of the two, may be implemented with one or more application modules. Similarly, a web browser enabling members to view web pages may be implemented with one or more application modules. Of course, other applications or services that utilize a radial menu module 124 and an input analysis module 126 may be separately implemented in their own application modules.

In addition to the various application server modules, the application logic layer includes a radial menu module 124 and an input analysis module 126. As illustrated in FIG. 1, in some embodiments, the radial menu module 124 and the input analysis module 126 are implemented as modules that operate in conjunction with various application modules. For instance, any number of individual application modules can invoke the functionality of the radial menu module 124 and the input analysis module 126 to receive user input and analyze it. However, in various alternative embodiments, the radial menu module 124 and the input analysis module 126 may be implemented as their own application modules such that they operate as a stand-alone application.

Generally, the radial menu module 124 displays and updates a radial menu as a user navigates through it. In some example embodiments, the radial menu module 124 only displays a radial menu in response to a specific initiation input from a user. An initiation input is any input that lets the computer device 120 know that the next input will be command input, as opposed to a regular user input. For example, a tap and hold gesture on a specific section of a touch screen display, pressing a specific button on a smart phone, or pressing a specific keyboard key combination may all alert the computer device 120 that the user wishes to input a command.

Once the initiation input is received by the computer device 120, the radial menu module 124 causes the basic radial menu to be displayed in the user interface. The basic radial menu includes one or more high-level menu options, each of which is positioned around a central area (e.g., a circle that is positioned where the initiation input was detected.) The computer device 120 then detects further input from the user to select one of the high-level menu options (e.g., the high-level options may include Edit, File, View, Input, and so on). In some example embodiments, the further input includes an input component (e.g., a gesture component) from the original input position to the section of the radial menu that represents one of the high-level menu options.

In response to input showing user selection of a respective high-level menu option in the plurality of displayed high-level menu options (e.g., movement of a finger into the area of the display representing the respective high-level menu option), the radial menu module 124 then updates the radial menu to include a second level of options. The second level of options is determined by the selected high-level option and is displayed proximate to the selected high-level option. For example, if the selected high-level option was “View”, the second-level options may include “Zoom in”, “Zoom out”, “Full Screen”, “Minimize”, and so on. These second-level options are then displayed adjacent to the “View” high-level option.

The radial menu module 124 then detects a second command component input from the user. The second command component represents selection of one of the displayed second-level options (e.g., a gesture to the second-level options). If the selected second-level option represents a completed command, the computer device 120 then executes the selected command. However, the second-level option may represent a further group of options (e.g., if the user selects “Zoom In”, there are many different zoom amounts that the user can select). In response, the radial menu module 124 would display yet another level of command options (e.g., third-level options). Indeed, the radial menu module 124 can display an arbitrary number of option levels.

Generally, the input analysis module 126 analyzes input received from a user to determine whether the user has learned specific command inputs and to determine whether a specific set of gesture components is part of a reference command input.

Each time a user uses the radial menu to select a particular command (e.g., through a plurality of input components), the input analysis module 126 determines whether that command should be added to the list of reference commands. In some example embodiments, the input analysis module 126 determines that a given command should be added to the list of reference commands if the user executes the command within a predefined amount of time (e.g., a user who executes a multi-component command very quickly likely knows the command). In some example embodiments, the radial menu module 124 displays and updates a radial menu as a user navigates through it. In some example embodiments, the input analysis module 126 determines that a given command is well known to the user and should be added as a reference command if the user executes the command such that at least some components of the multi-component command are received from the user before the radial menu has been updated to display the associated options (e.g., the user is entering the full multi-component command faster than the radial menu can update).

The input analysis module 126 builds a list of reference commands that the user is able to enter without needing the radial menu for reference. The input analysis module 126 then analyzes each input component to determine whether to display the radial menu or not.

The input analysis module 126 detects a first component of a command input. The input analysis module 126 then determines whether the detected first component matches the first component of any of the stored list of reference commands. In accordance with a determination that the first component does not match the first component of any reference command, the input analysis module 126 causes the radial menu to be displayed.

In accordance with a determination that the first component matches at least one of the reference commands, the input analysis module 126 prevents the radial menu from being displayed.

This process repeats, with the input analysis module 126 analyzing each new input component to determine whether the combined already received components match, as a group and in order, the corresponding components of at least one reference command. If at any time the combined components no longer match a reference command, the input analysis module 126 causes the radial menu module 124 to display the radial menu at the correct depth level. Thus, if the computer device 120 has already received two components of a multi-component input command, the radial menu is displayed with the extra option levels already visible based on the previously received components.

Similarly, if the user pauses and fails to enter another input component for a particular amount of time, the input analysis module 126 causes the radial menu to be displayed. In this way, a user can enter the components that the user is comfortable with, and if the user forgets the next step the input analysis module 126 will cause the radial menu to be displayed at the appropriate level.

In some example embodiments, the input analysis module 126 receives a component that completes a full multi-component command. In response, the input analysis module 126 then executes the command.

In some example embodiments, a third party server 150 stores user data 152. This user data 152 can incorporate any information about the user, including, but not limited to, user preferences, user history, user location, user demographic information, and command gesture data 132 for the user. In some example embodiments, the user can switch from one computer device 120 to a different computer device and import all the relevant user profile data from the user data 152 stored at the third party server 150. In this way, the user's reference multi-component command data will be available at the new device and the user's muscle memory can be utilized.

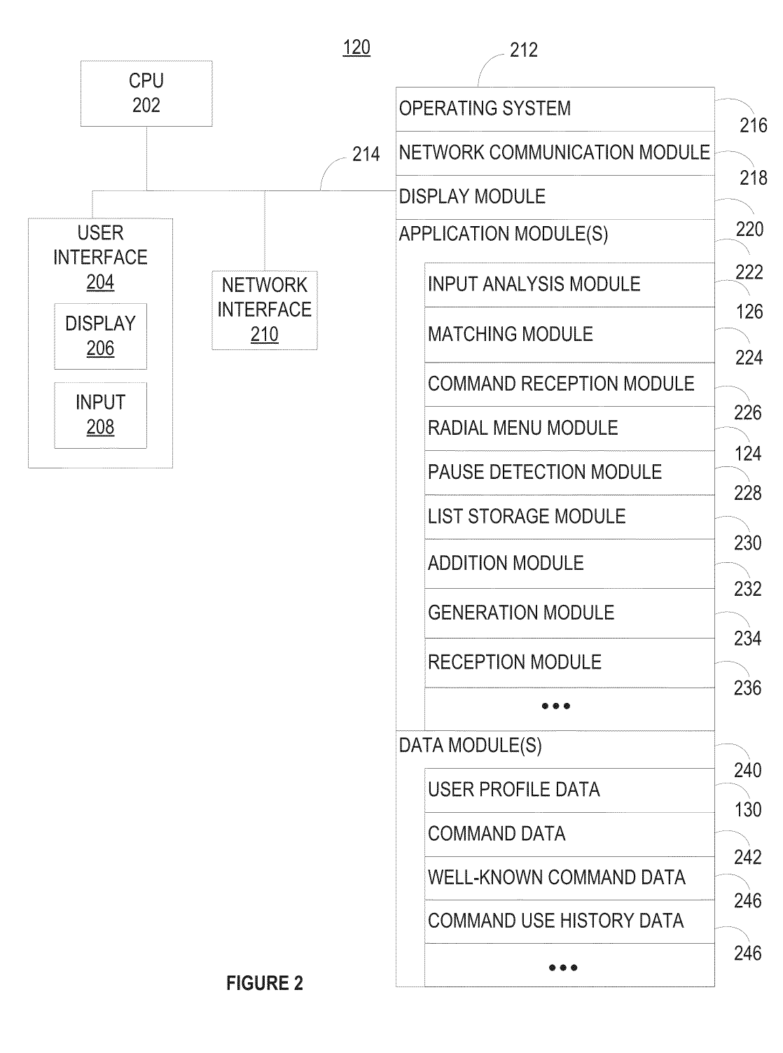

FIG. 2 is a block diagram illustrating a computer device 120, in accordance with an example embodiment. The computer device 120 typically includes one or more processing units (CPU's) 202, one or more network interfaces 210, a memory 212, and one or more communication buses 214 for interconnecting these components. The computer device 120 includes a user interface 204. The user interface 204 includes a display 206 and optionally includes an input 208, such as a keyboard, mouse, touch-sensitive display, or other input means. Furthermore, some computer devices 120 use a microphone and voice recognition to supplement or replace the keyboard.

Memory 212 includes high-speed random-access memory, such as dynamic random-access memory (DRAM), static random-access memory (SRAM), double data rate random-access memory (DDR RAM), or other random-access solid-state memory devices, and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory device(s) within memory 212, comprise(s) a non-transitory computer readable storage medium.

In some embodiments, memory 212 or the computer readable storage medium of memory 212 stores the following programs, modules, and data structures, or a subset thereof:
an operating system 216 that includes procedures for handling various basic system services and for performing hardware dependent tasks;
a network communication module 218 that is used for connecting the computer device 120 to other computers via the one or more network interfaces 210 (wired or wireless) and one or more communication networks, such as the Internet, other wide area networks, local area networks, metropolitan area networks, etc.;
a display module 220 for enabling the information generated by the operating system 216 and applications modules 222 to be presented visually on the display 206;
one or more application modules 222 for handling various aspects of providing the services associated with the computer device 120, including but not limited to:
   an input analysis module 126 for receiving input components and determining whether the input components match any of the input components associated with commands in the list of reference commands;
   a matching module 224 for matching input components (or groups of input components) against stored components of reference commands in the list of reference commands;
   a command reception module 226 for receiving commands from the user and determining the speed and accuracy that the user has when entering commands through a radial menu to identify commands that the user knows well (e.g., by muscle memory);
   a radial menu module 124 for displaying and altering a radial menu based on the user's input;
   a pause detection module 228 for determining whether the user has paused long enough to represent uncertainty and whether to display the radial menu in response to the pause;
   a list storage module 230 for storing a list of reference commands and determining when a command has become well known; and
   an addition module 232 for adding a command to a list of reference user commands;
   a generation module 234 for generating a list of reference user commands based on a user's command input history;
   a reception module 236 for receiving one or more components of a multi-component command; and
a data module 240, for storing data relevant to the computer device 120, including but not limited to:
   user profile data 130 for storing profile data related to a user of the computer device 120;
   command data 242, including data related to commands that can be executed by the computer device 120 including the positions of different commands in a radial menu;
   reference command data 244 including a list of all the components of one or more multi-component commands that are determined to be well known to the user of the computer device 120; and
   command use history data 246 including a list of all used commands and the number of instances that each command is used.

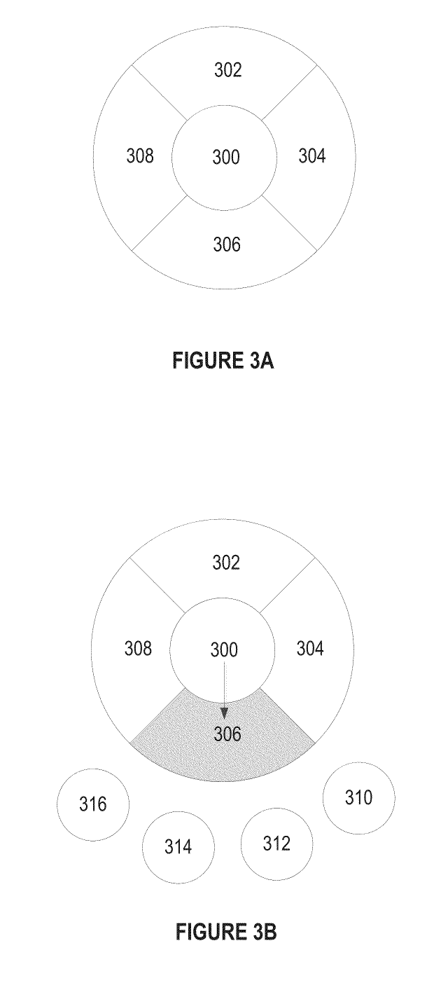

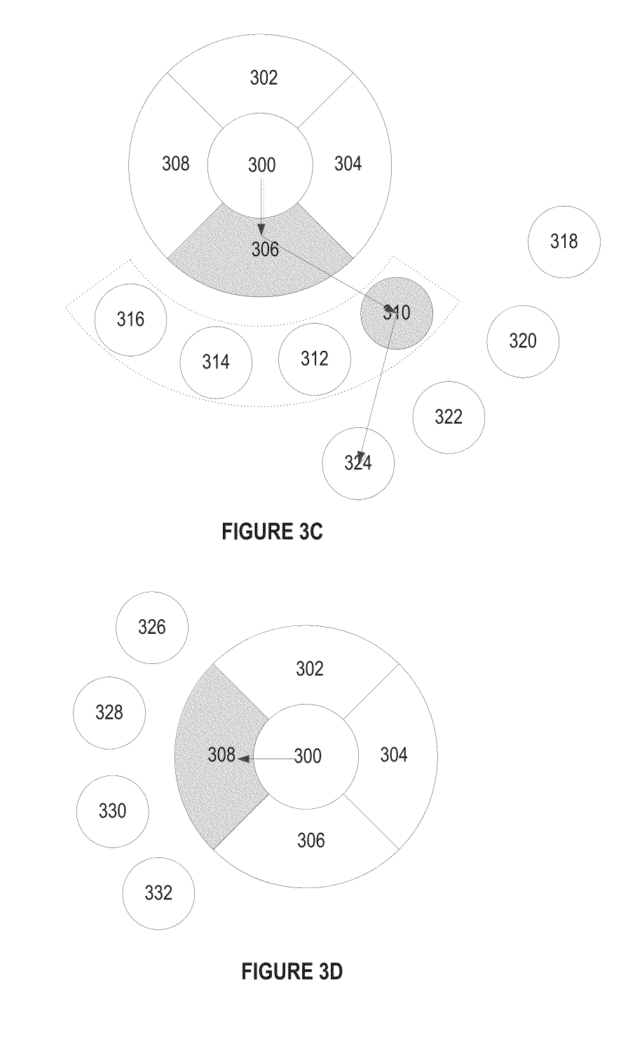

FIGS. 3A and 3B illustrate an exemplary radial menu 300, in accordance with an example embodiment. According to one embodiment, the radial menu is context-sensitive and is displayed after a user provides an initiation input via a user input device (e.g., a mouse, a touchpad, a touch screen, or a spatial gesture). In a radial menu, menu items are displayed as wedges in a circle radiating from a circular menu center. The radial menu 300 provides improved efficiency in acquisition of menu selections, reduced selection errors, and increased selection speed.

The radial menu 300 includes four wedges (wedges 302, 304, 306, and 308). Each wedge represents a group of menu items.

FIG. 3B shows the user selecting a specific wedge (the wedge 306). In some example embodiments, the user selects the wedge 306 by sliding a finger contact from a first position in the radial menu 300 to the area associated with the wedge 306. In response, the computer device 120 displays a secondary level of menu items (menu items 310, 312, 314, and 316) that radiates out from the selected wedge 306. For example, the user selects the wedge 306 by hovering a cursor for a particular period of hovering time over the wedge 306. In some example embodiments, each menu item represents a command that the computer device (e.g., the computer device 120 of FIG. 1) can execute, and selecting the menu item will result in the immediate execution of the command. In other embodiments, the respective menu item represents a category of further menu items that are displayed when the respective menu item is selected.

The user may further continue to navigate to select a menu item from the secondary level of menu items 310 to 316. In some example embodiments, a menu item is selected by placing a cursor over the menu item for a predetermined amount of time. According to one embodiment, the predetermined amount of time for hovering over a particular wedge or menu item is customizable by the user. For example, the amount of hovering time may be one half of a second (0.5 seconds). The hovering time may be the same for the various menus or may be set differently for each wedge or menu item to provide different hovering times for each wedge or menu item.

While FIGS. 3A and 3B illustrate four wedges 302 to 308, it is understood that there may be any number of wedges based on design criteria and an application. In certain embodiments, the number of wedges may range from three to five wedges. Similarly, although FIG. 3B illustrates a secondary level of four menu items 310 to 318, it is understood that there may be any number of secondary levels and any number of menu items in a secondary level. In other embodiments, the number of menu items of a secondary level of menu items ranges from two to six. While the menu items shown in FIGS. 3A-3B are displayed as wedges and circles, menu items can also be displayed in a variety of other shapes such as oblongs, squares, polygonal FIGS., and customizable shapes.

In some example embodiments, the computer device 120 provides a selection of a menu item on a radial menu with a single continuous user movement (e.g., gesture) via various user input devices (e.g., a mouse, a touchpad, a touch screen, or a spatial gesture). For instance, the movement can be based on dragging a mouse, a finger gesture across a touchpad or a touch screen, or a spatial hand gesture. In this case, a user does not need to read or comprehend the menu before selecting the menu item using a series of selections. Instead, the user can rely on muscle memory to perform a single motion. The present system interprets the movement to determine and actuate the menu item. According to one embodiment, a user (e.g., an expert user) may perform a single continuous movement without waiting for the radial menu to be displayed on a display screen.

FIGS. 3C and 3D illustrate an exemplary radial menu 300, in accordance with some example embodiments. FIG. 3C represent a continuation of the example shown in FIGS. 3A and 3B. In FIG. 3C, the user has selected one of the menu items in the second-level hierarchy (in this example, the user selects the menu item 310). In some example embodiments, the selection of the menu item 310 is the result of the user changing the direction of a finger gesture from straight down to angled to the right (e.g., to reach the menu item 310.) In response, the computer device 120 displays a further sub-menu that includes menu items 318, 320, 322, and 324. The user can then select a menu item from the new sub-menu. In FIG. 3C, the user selects menu item 324 by moving down and to the left.

FIG. 3D represents an alternative selection to the selection found in FIGS. 3B and 3C. In FIG. 3D the user selects the wedge 308 instead of the wedge 306. As in FIG. 3B, the computer device 120 displays several menu items 326, 328, 330, and 332, but positions them closer to the selected wedge 308 rather than where the menu items in FIG. 3B were positioned.

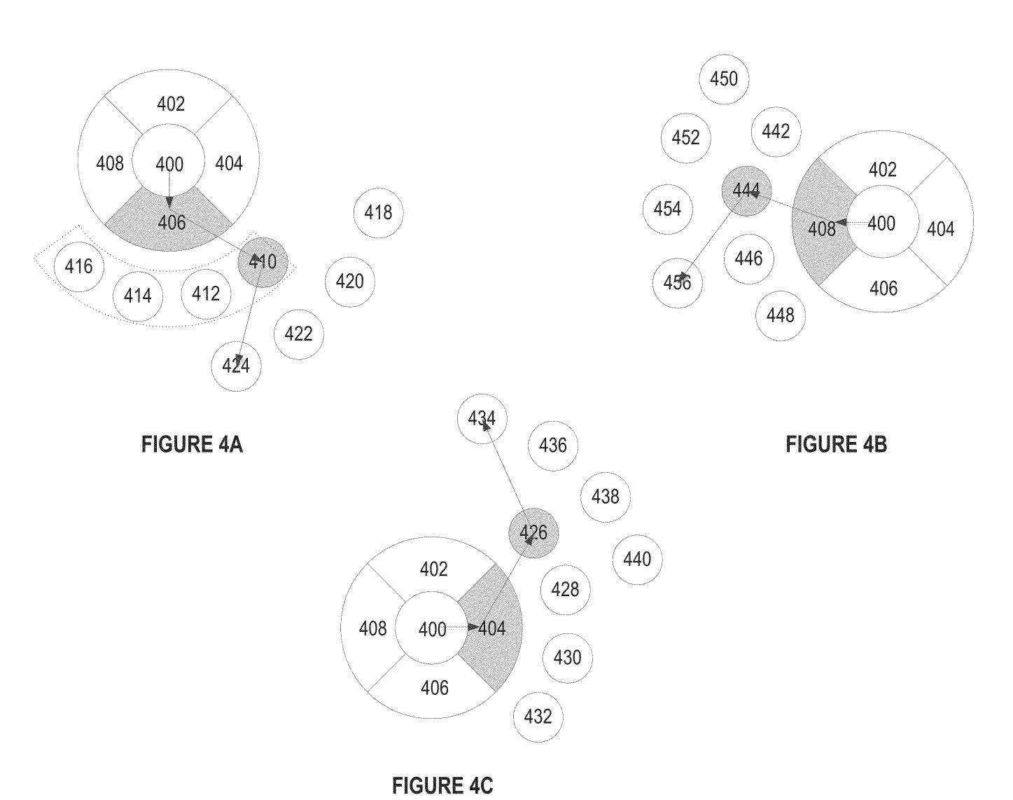

FIGS. 4A-4C illustrate an exemplary representation of a number of reference multi-component user inputs (e.g., gestures), in accordance with an example embodiment. As can be seen, each of FIGS. 4A-4C represents a different multi-component user input pattern that starts at a middle position 400 (e.g., the initial position in the middle of the radial menu). In some example embodiments, this initial position is based on the position of the initiating input (e.g., the user taps and holds on a specific portion of the screen and the radial menu appears in that location with the middle position 400 being centered at the location of the tap gesture). The radial menu in FIGS. 4A-4C include a plurality of menu items, most of which are not selected by the user (e.g., menu items 402-456).

The multi-component user input shown in FIG. 4A starts in the middle position 400 and involves a component of moving (e.g., of a finger swipe gesture) straight down to select a wedge 406. The next component of the multi-component gesture is a swipe or other user input that moves to a menu item 410 by moving at an angle down and to the right (at a particular angle) a certain distance. Once the menu item 410 is selected, the next input component moves down and to the left to select a menu item 424. In response, the command associated with the menu item 424 is executed.

The multi-component user input shown in FIG. 4B starts in the middle position 400 and involves a component of moving (e.g., of a finger swipe gesture) straight left to select a wedge 408. The next component of the multi-component gesture is a swipe or other user input that moves to a menu item 444 by moving at an angle up and to the left (at a particular angle) a certain distance. Once the menu item 444 is selected, the next input component moves down and to the left to select a menu item 456. In response, the command associated with the menu item 456 is executed.

The multi-component user input shown in FIG. 4C starts in the middle position 400 and involves a component of moving (e.g., of a finger swipe gesture) straight right to select a wedge 404. The next component of the multi-component gesture is a swipe or other user input that moves to a menu item 426 by moving at an angle up and to the right (at a particular angle) a certain distance. Once the menu item 426 is selected, the next input component moves up and to the left to select a menu item 434. In response, the command associated with the menu item 434 is executed.

The multi-component user inputs for each of the three reference commands are stored by the computer device (e.g., the computer device 120 in FIG. 1) such that the computer device knows the direction, length, and time of each component in the multi-component user input.

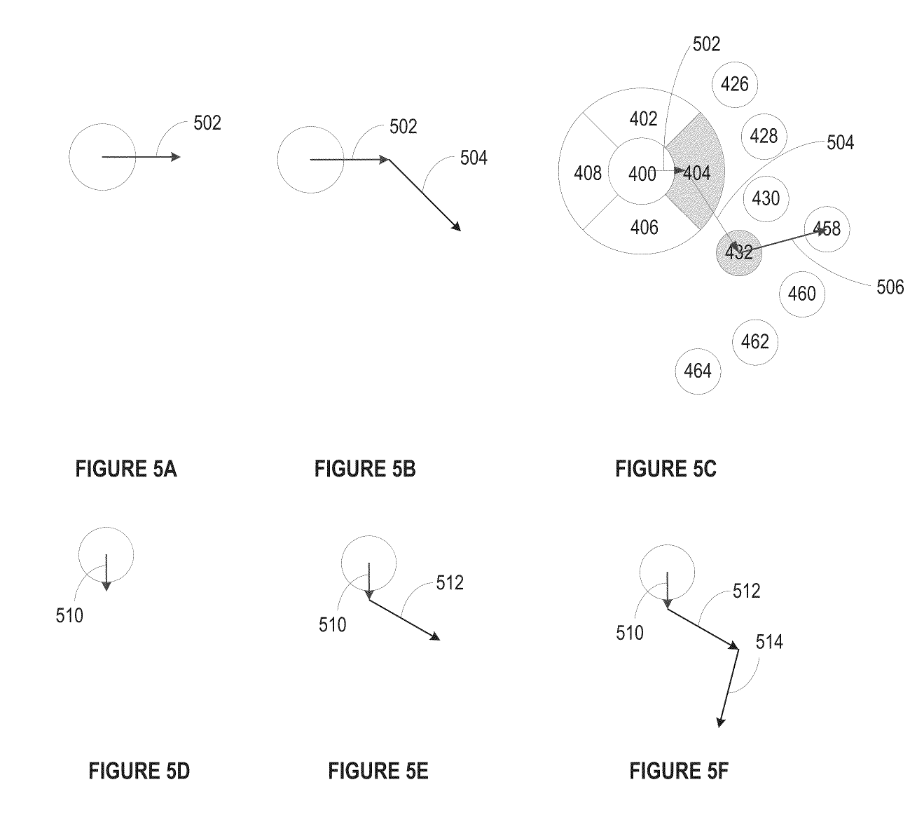

FIGS. 5A-5F illustrate an exemplary representation of a series of input components received from a user through an input device (e.g., a touch screen display), in accordance with an example embodiment. The computer device (e.g., the computer device 120 in FIG. 1) analyzes each input component as it is received and compares the received input components against the corresponding components in a list of reference commands.

FIG. 5A represents a first input component 502. The first input component 502 is a gesture or other input to the right. The input analysis module (e.g., the input analysis module 126 of FIG. 1) determines whether the first input component 502 matches the first component from any of the stored list of reference commands. Using the multi-component commands shown in FIGS. 4A-4C, the input analysis module (e.g., the input analysis module 126 of FIG. 1) determines that the first input component 502 does not match the first component of the multi-component commands shown in FIGS. 4A and 4B, but does match the first component of the multi-component command represented by FIG. 4C (e.g., directly to the right to the wedge 404). Thus, the radial menu is not displayed as long as the input does not pause after the first input component longer than the computer device (e.g., the computer device 120 in FIG. 1) allows.

FIG. 5B represents a second input component 504 being added after the first input component 502. The input analysis module (e.g., the input analysis module 126 of FIG. 1) determines whether the two components together match the first two components of any reference commands stored in the list of reference commands. In this example, the input analysis module (e.g., the input analysis module 126 of FIG. 1) only analyzes the multi-component command represented in FIG. 4C because it has already determined that the multi-component commands represented by FIGS. 4A and 4B do not match the first input component 502. The input analysis module (e.g., the input analysis module 126 of FIG. 1) then determines that the most recent input component 504 does not match the corresponding component in the multi-component command represented in FIG. 4C because the most recent component moves to a menu item that is down approximately 45 degrees and to the right. In contrast, the multi-component command represented in FIG. 4C has a second input component that moves up and to the right.

In accordance with a determination that the first two components received (the input components 502 and 504) do not match any of the multi-component commands stored as reference commands, the input analysis module (e.g., the input analysis module 126 of FIG. 1) causes the full radial menu to be displayed as shown in FIG. 5C (e.g., a radial menu including menu items 402, 404, 406, 408, 426, 528, 430, 432, 458, 460, 462, and 464). In this way the user is able to complete the multi-component command with the visual aid of the radial menu. The user then selects a menu item 434 with another input component 506, and the particular command represented by the menu item 458 is executed.

FIG. 5D represents a first input component 510. The first input component 510 is a gesture or other input straight down. The input analysis module (e.g., the input analysis module 126 of FIG. 1) determines whether the first input component 502 matches the corresponding component (e.g., the first component) from any of the stored list of reference commands. Using the multi-component commands shown in FIGS. 4A-4C, the input analysis module (e.g., the input analysis module 126 of FIG. 1) determines that the first input component 510 does not match the first component of the multi-component commands shown in FIGS. 4B and 4C but does match the first component of the multi-component command represented by FIG. 4A (e.g., directly down to the wedge 406). Thus, the radial menu is not displayed as long as the input does not pause after the first input component longer than the computer device (e.g., the computer device 120 in FIG. 1) allows.

FIG. 5E represents a second input component 512 being added after the first input component 510. The input analysis module (e.g., the input analysis module 126 of FIG. 1) determines whether the two components together match the first two components of any reference commands stored in the list of reference commands. In this example, the input analysis module (e.g., the input analysis module 126 of FIG. 1) only analyzes the multi-component command represented in FIG. 4A because it has already determined that the multi-component commands represented by FIGS. 4B and 4C do not match the first input component 510. The input analysis module (e.g., the input analysis module 126 of FIG. 1) then determines that the second input component 512 does match the corresponding component in the multi-component command represented in FIG. 4C because the most recent component moves to a menu item that is down approximately 45 degrees and to the right. Similarly, the second component of the multi-component command represented in FIG. 4A has a second component that moves down and to the right.

The input analysis module (e.g., the input analysis module 126 of FIG. 1) then receives a third component 514 of the multi-component command and compares the third component 514 to the corresponding components of the reference commands in the list of reference commands. In this example, the input analysis module (e.g., the input analysis module 126 of FIG. 1) determines that the third component 514 matches the third component shown in the multi-component command represented in FIG. 4A. As such, the radial menu is not displayed. In this example, the third component 514 is a movement to the menu item 424. The menu item 424 represents a final component of a multi-component command, and thus once the third component 514 is received, the command is executed.

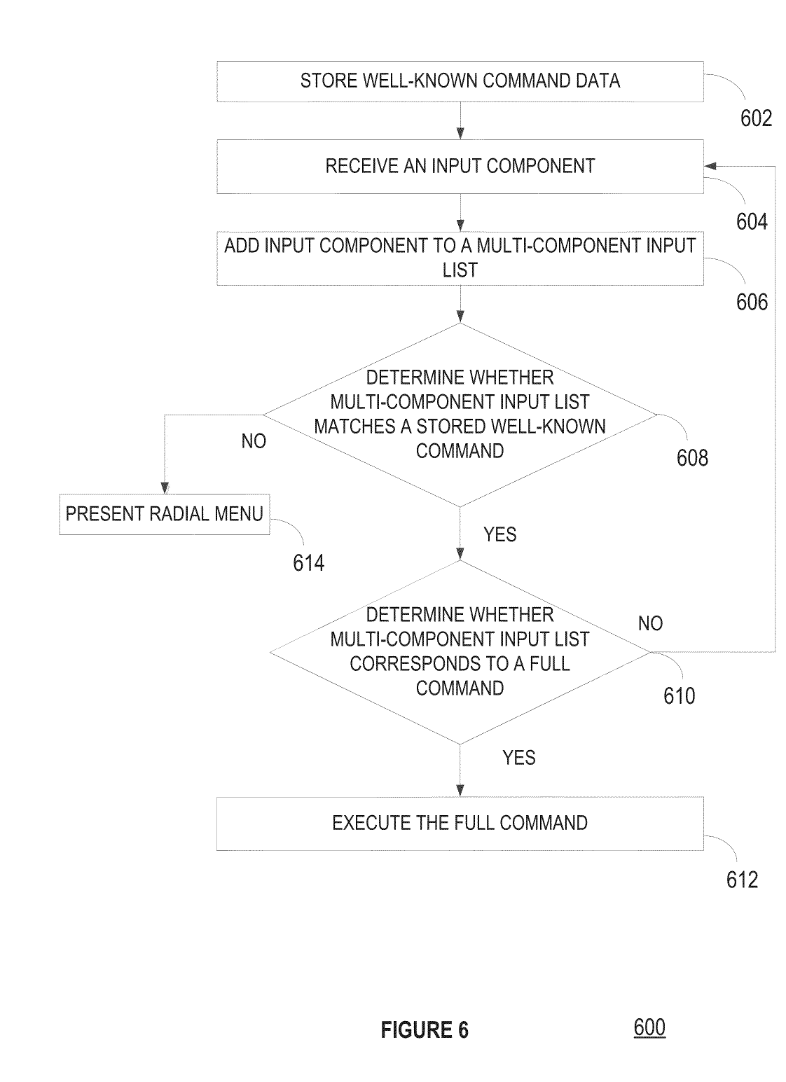

FIG. 6 is a flow diagram illustrating a method 600, in accordance with an example embodiment, for improving input efficiency through muscle memory. Each of the operations shown in FIG. 6 may correspond to instructions stored in a computer memory or computer readable storage medium. In some embodiments, the method 600 described in FIG. 6 is performed by the computer device (e.g., the computer device 120 in FIG. 1).

In some embodiments, the method 600 is performed at a computer device (e.g., the computer device 120 in FIG. 1) including one or more processors and memory storing one or more programs for execution by the one or more processors.

The computer device (e.g., the computer device 120 in FIG. 1) stores (602) data for one or more reference commands. Reference commands are multi-component commands for which the user of the computer device (e.g., the computer device 120 in FIG. 1) has demonstrated proficiency (e.g., the user can reliably enter the command without the need to see the radial menu) based on the previous history of the user or the explicit preferences of the user.

The computer device (e.g., the computer device 120 in FIG. 1) then receives (604) a first input component from a user through an input device (e.g., a touch screen or input device such as a mouse). In some example embodiments, the user first uses an initiation input to notify the computer device (e.g., the computer device 120 in FIG. 1) that command input will be given.

The computer device (e.g., the computer device 120 in FIG. 1) then adds (606) the received input component to the multi-component input list (e.g., a list of all the input components for a particular multi-component command). In this way the entire group of components can be tracked and compared to reference commands or used to display a radial menu in the middle of a multi-component command if needed.

The computer device (e.g., the computer device 120 in FIG. 1) then determines (608) whether the multi-component input list matches any multi-component command stored in the list of reference commands. Matching is done by comparing each input component against the corresponding component of each reference command. For example, if each component is a swipe gesture on a touch screen, the computer device (e.g., the computer device 120 in FIG. 1) compares the angle and length of each swipe. If the inputs are mouse clicks, the computer device (e.g., the computer device 120 in FIG. 1) compares the position of each click, and so on.

In accordance with a determination that the list of input components does not match any reference command, the computer device (e.g., the computer device 120 in FIG. 1) then presents (614) the radial menu for the user to reference. In some example embodiments, the radial menu includes information representing the past user input components (e.g., shows which menu items were selected to arrive at the current state).

In accordance with a determination that the list of input components does match at least one reference command, the computer device (e.g., the computer device 120 in FIG. 1) then determines (610) whether the multi-component input list corresponds to a complete command (e.g., all components have been entered that are part of selecting a specific command). In accordance with a determination that the multi-component input list corresponds to a complete command, the computer device (e.g., the computer device 120 in FIG. 1) then executes (612) the complete command. For example, if the “copy” command needs three gestures to be selected (e.g., two menu options and the menu item representing copy), the computer device (e.g., the computer device 120 in FIG. 1) would determine whether all three gestures had been received, and if so, the computer device (e.g., the computer device 120 in FIG. 1) executes the “copy” command.

In accordance with a determination that the multi-component input list does not correspond to a complete command, the computer device (e.g., the computer device 120 in FIG. 1) then waits to receive (604) additional input components.

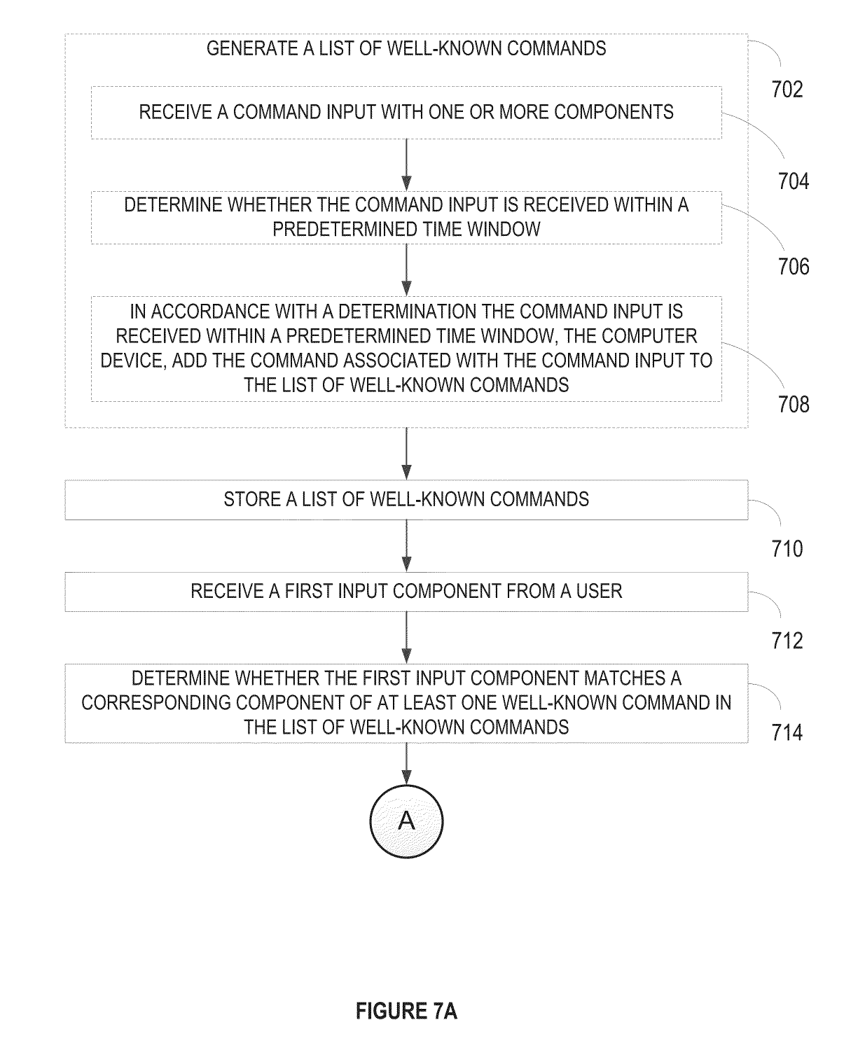

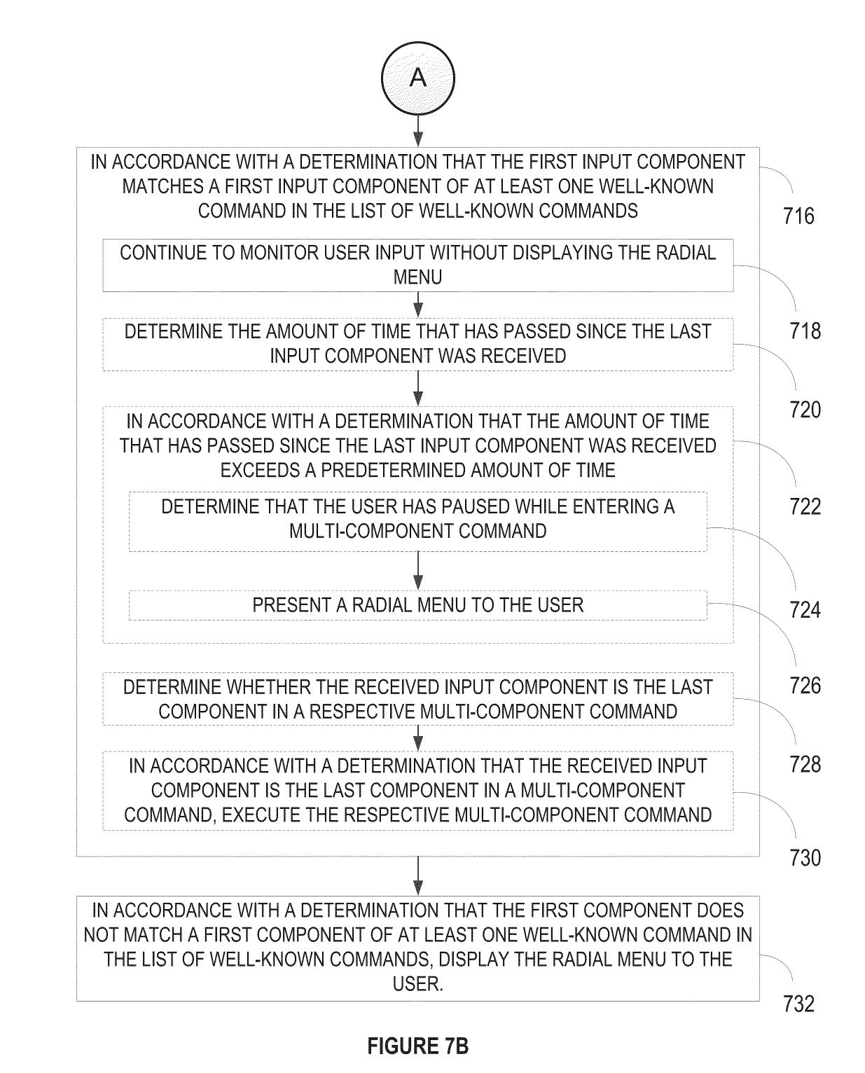

FIG. 7A is a flow diagram illustrating a method, in accordance with an example embodiment, for improving command input efficiency through muscle memory. Each of the operations shown in FIG. 7A may correspond to instructions stored in a computer memory or computer readable storage medium. Optional operations are indicated by dashed lines (e.g., boxes with dashed-line borders). In some embodiments, the method described in FIG. 7A is performed by the computer device (e.g., the computer device 120 in FIG. 1). However, the method described can also be performed by any other suitable configuration of electronic hardware.

In some embodiments, the method is performed at a computer device (e.g., the computer device 120 in FIG. 1) including one or more processors and memory storing one or more programs for execution by the one or more processors.

The computer device (e.g., the computer device 120 in FIG. 1) generates (702) a list of reference commands. In this context, commands are operations or functions that the computer device (e.g., the computer device 120 in FIG. 1) can perform in response to user input (e.g., saving, loading, opening, copying, pasting, or any other command, function, or operations that a user would find useful) and reference commands are a subset of all commands that the user knows well enough that visual display of the radial menu is not necessary for the user to input the command.

The computer device (e.g., the computer device 120 in FIG. 1) generates a list of reference commands by receiving (704) a command input with one or more components. In some example embodiments, the command input includes all the components needed for a full command. In this way the computer device (e.g., the computer device 120 in FIG. 1) is able to analyze user inputs that activate specific commands or functions.

The computer device (e.g., the computer device 120 in FIG. 1) then determines (706) whether the command input is received within a predetermined time window. That is to say, the computer device (e.g., the computer device 120 in FIG. 1) determines the total time from receiving the first component of the multi-component command until that command is executed. For example, a user who has good muscle memory for a particular sequence of inputs to get a specific command to execute will perform that sequence of inputs much faster than a user who has to navigate through the radial menu to find the desired command. In some example embodiments, the length of the predetermined time window is a fixed value such as 0.5 seconds. In other embodiments, the length of the predetermined time window is device-specific and based on how long it takes the device to update the radial menu. Thus, as long as the user enters the entire multi-component command before the computer device (e.g., the computer device 120 in FIG. 1) has displayed the full menu output (e.g., before all the expanded menu items are displayed), the command is determined to be faster than the predetermined time.

In accordance with a determination that the command input is received within a predetermined time window, the computer device (e.g., the computer device 120 in FIG. 1) adds (708) the command associated with the command input to the list of reference commands. Thus, if the user has shown enough familiarity with a particular multi-component command to input it faster than the predetermined time, the computer device (e.g., the computer device 120 in FIG. 1) determines that the command is well known (or well-practiced) to the user. The command is then added (along with its respective input component data) to a list of reference commands, for later use.

In some example embodiments, the computer device (e.g., the computer device 120 in FIG. 1) stores (710) a list of reference commands. For example, the computer device (e.g., the computer device 120 in FIG. 1) has a database that stores a list of commands that the user knows well enough that display of the radial menu is not necessary for the user to enter the correct sequence of gestures or inputs. In some example embodiments, the list of reference commands includes lists of commands that the user partially knows (e.g., the user knows the first one or two components but then is unable to finish the command without the radial menu). In this way the computer device (e.g., the computer device 120 in FIG. 1) assists the user in learning new commands.

The computer device (e.g., the computer device 120 in FIG. 1) receives (712) a first input component from a user. The input can be from any input device. For example, the input may include gestures on a touch screen, mouse clicks, keystrokes on a keyboard, and any other types of input.

In some example embodiments, input components are finger gestures on a touch screen display. For example, input components may be tap gestures, hold gestures, tap and hold gestures, multi-finger gestures, swipe gestures, and so on.

In some example embodiments, each reference command in the list of reference commands includes one or more components. In some example embodiments, prior to receiving command input, the computer device receives a command initiation input.

The computer device (e.g., the computer device 120 in FIG. 1) then determines (714) whether the first input component matches a corresponding component of at least one reference command in the list of reference commands. For example, if the input components are finger swipe gestures, each component will have an associated angle and distance. The computer device (e.g., the computer device 120 in FIG. 1) then compares the relative starting position, angle (or direction), and distance of the input component to the corresponding input component (e.g., first, second, third, and so on) for each of the stored reference commands.

FIG. 7B is a flow diagram illustrating a method, in accordance with an example embodiment, for improving command input efficiency through muscle memory, continuing from FIG. 7A. Each of the operations shown in FIG. 7B may correspond to instructions stored in a computer memory or computer readable storage medium. Optional operations are indicated by dashed lines (e.g., boxes with dashed-line borders). In some embodiments, the method described in FIG. 7B is performed by the computer device (e.g., the computer device 120 in FIG. 1). However, the method described can also be performed by any other suitable configuration of electronic hardware.

In some embodiments, the method is performed at a computer device (e.g., the computer device 120 in FIG. 1) including one or more processors and memory storing one or more programs for execution by the one or more processors.

In accordance with a determination that the first input component matches a first input component of at least one reference command in the list of reference commands (716), the computer device (e.g., the computer device 120 in FIG. 1) continues (718) to monitor user input without displaying the radial menu.

In some example embodiments, the computer device (e.g., the computer device 120 in FIG. 1) determines (720) the amount of time that has passed since the last input component was received. Thus, if a user pauses between components of a multi-component command, this value will be higher.

In accordance with a determination that the amount of time that has passed since the last input component was received exceeds a predetermined amount of time (722), the computer device (e.g., the computer device 120 in FIG. 1) determines (724) that the user has paused while entering a multi-component command. For example, if the predetermined amount of time is 0.5 seconds, the computer device (e.g., the computer device 120 in FIG. 1) will determine that a user has paused when the user waits more than 0.5 seconds before inputting the next component (e.g., a finger gesture, a mouse click, or a keystroke). The computer device (e.g., the computer device 120 in FIG. 1) will then present (726) the radial menu to the user. Thus, if the user pauses, the computer device (e.g., the computer device 120 in FIG. 1) will present the radial menu to the user to help the user find the menu item that the user wants to select.

In some example embodiments, the computer device (e.g., the computer device 120 in FIG. 1) determines (728) whether the received input component is the last component in a multi-component command. In accordance with a determination that the received input component is the last component in a multi-component command, the computer device (e.g., the computer device 120 in FIG. 1) executes (730) the respective multi-component command.

In accordance with a determination that the first component does not match a first component of at least one reference command in the list of reference commands, the computer device (e.g., the computer device 120 in FIG. 1) displays (732) the radial menu to the user.

### Software Architecture

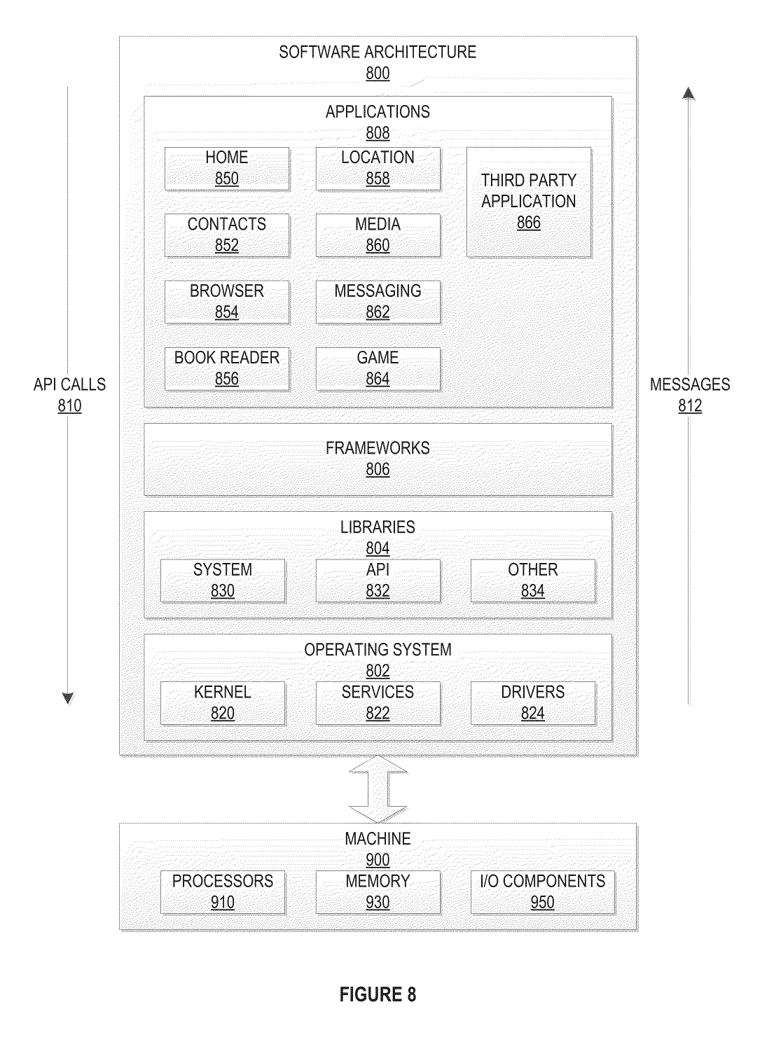

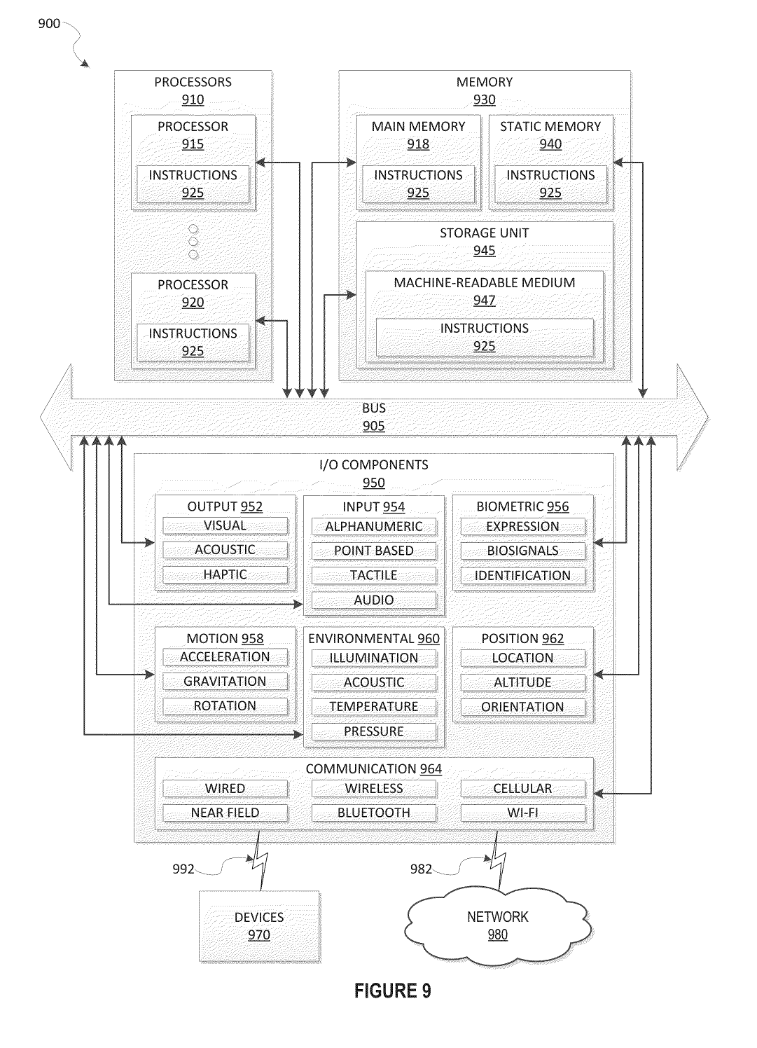

FIG. 8 is a block diagram illustrating an architecture of software 800, in accordance with an example embodiment, which may be installed on any one or more of the devices of FIG. 1 (e.g., the computer device 120). FIG. 8 is merely a non-limiting example of a software architecture and it will be appreciated that many other architectures may be implemented to facilitate the functionality described herein. The software 800 may be executing on hardware such as a machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 808. Operationally, the applications 808 may invoke application programming interface (API) calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 808. The libraries 804 may include system libraries (e.g., C standard library) 830 that may provide functions such as memory allocation functions, string manipulation functions, mathematic functions, and the like. In addition, the libraries 804 may include API libraries 832 such as media libraries (e.g., libraries to support presentation and manipulation of various media formats, such as MPEG4, H.264, MP3, AAC, AMR, JPG, or PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 808.

The frameworks 806 may provide a high-level common infrastructure that may be utilized by the applications 808. For example, the frameworks 806 may provide various graphic user interface (GUI) functions, high-level resource management, high-level location services, and so forth. The frameworks 806 may provide a broad spectrum of other APIs that may be utilized by the applications 808, some of which may be specific to a particular operating system or platform.

The applications 808 include a home application 850, a contacts application 852, a browser application 854, a book reader application 856, a location application 858, a media application 860, a messaging application 862, a game application 864, and a broad assortment of other applications, such as a third party application 866. In a specific example, the third party application 866 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 866 may invoke the API calls 810 provided by the operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software, a program, an application, an applet, an app, or other executable code) for causing the machine 900 to perform any one or more of the methodologies discussed herein may be executed. In alternative embodiments, the machine 900 operates as a stand-alone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by the machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 915 and a processor 920 that may execute instructions 925. The term “processor” is intended to include multi-core processors that may comprise two or more independent processors (also referred to as “cores”) that may execute instructions contemporaneously. Although FIG. 9 shows multiple processors, the machine 900 may include a single processor with a single core, a single processor with multiple cores (e.g., a multi-core processor), multiple processors with a single core, multiple processors with multiples cores, or any combination thereof.

The memory 930 may include a main memory 918, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 918, within the static memory 940, within at least one of the processors 910 (e.g., within the processor's cache memory), or any suitable combination thereof, during execution thereof by the machine 900. Accordingly, the main memory 918, the static memory 940, and the processors 910 may be considered machine-readable media 947.

As used herein, the term “memory” refers to a machine-readable medium 947 able to store data temporarily or permanently, and may be taken to include, but not be limited to, random-access memory (RAM), read-only memory (ROM), buffer memory, flash memory, and cache memory. While the machine-readable medium 947 is shown in an example embodiment to be a single medium, the term “machine-readable medium” should be taken to include a single medium or multiple media (e.g., a centralized or distributed database, or associated caches and servers) able to store instructions 925. The term “machine-readable medium” shall also be taken to include any medium, or combination of multiple media, that is capable of storing instructions (e.g., the instructions 925) for execution by a machine (e.g., the machine 900), such that the instructions, when executed by one or more processors of the machine (e.g., the processors 910), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or another pointing instrument), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure, from which altitude may be derived), orientation sensor components (e.g., magnetometers), and the like.

Communication may be implemented using a wide variety of technologies. The I/O components 950 may include communication components 964 operable to couple the machine 900 to a network 980 and/or to devices 970 via a coupling 982 and a coupling 992 respectively. For example, the communication components 964 may include a network interface component or another suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine and/or any of a wide variety of peripheral devices (e.g., a peripheral device coupled via a Universal Serial Bus (USB)).

Moreover, the communication components 964 may detect identifiers and/or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 964, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 925 may be transmitted and/or received using a transmission medium via the coupling 992 (e.g., a peer-to-peer coupling) to the devices 970. The term “transmission medium” shall be taken to include any intangible medium that is capable of storing, encoding, or carrying the instructions 925 for execution by the machine 900, and includes digital or analog communications signals or other intangible media to facilitate communication of such software.

Furthermore, the machine-readable medium 947 is non-transitory (in other words, not having any transitory signals) in that it does not embody a propagating signal. However, labeling the machine-readable medium 947 “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific embodiments. However, the illustrative discussions above are not intended to be exhaustive or to limit the possible embodiments to the precise forms disclosed. Many modifications and variations are possible in view of the above teachings. The embodiments were chosen and described in order to best explain the principles involved and their practical applications, to thereby enable others skilled in the art to best utilize the various embodiments with various modifications as are suited to the particular use contemplated.

It will also be understood that, although the terms “first,” “second,” etc. may be used herein to describe various elements, these elements should not be limited by these terms. These terms are only used to distinguish one element from another. For example, a “first contact” could be termed a “second contact,” and, similarly, a “second contact” could be termed a “first contact,” without departing from the scope of the present embodiments. The first contact and the second contact are both contacts, but they are not the same contact.

The terminology used in the description of the embodiments herein is for the purpose of describing particular embodiments only and is not intended to be limiting. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining (the stated condition or event)” or “in response to determining (the stated condition or event)” or “upon detecting (the stated condition or event)” or “in response to detecting (the stated condition or event),” depending on the context.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
storing a list of reference commands in memory, wherein a reference command is a command with an associated gesture that a user can execute without display of a radial menu;
receiving, via a hardware input, a first input component from a user;
determining, using one or more hardware processors, whether the first input component matches a first component of at least one reference command in the list of reference commands;
in accordance with a determination that the first input component matches the first component of the at least one reference command in the list of reference commands, continuing to monitor user input without displaying a radial menu; and
in accordance with a determination that the first input component does not match the first component of the at least one reference command in the list of reference commands, causing the radial menu to be displayed to the user on a display device.

2. The method of claim 1, further including generating the list of reference commands.

3. The method of claim 2, wherein generating the list of reference commands comprises:
receiving a command input with one or more components;
determining whether the command input is received within a predetermined time window; and
in accordance with a determination that the command input is received within the predetermined time window, adding a command associated with the command input to the list of reference commands.

4. The method of claim 1, wherein each reference command in the list of reference commands includes one or more components.

5. The method of claim 1, further comprising, prior to receiving the first input component, receiving a command initiation input.

6. The method of claim 1, wherein the input component is finger gestures on a touch screen display.

7. The method of claim 1, further comprising, in accordance with a determination that the first input component matches the first component of the at least one reference command in the list of reference commands:
determining an amount of time that has passed since a last input component was received; and
in accordance with a determination that the amount of time that has passed since the last input component was received exceeds a predetermined amount of time:
determining that the user has paused while entering a multi-component command; and
presenting the radial menu to the user.

8. The method of claim 1, further comprising:
after receiving an input component, determining whether the received input component is a last component in any of a plurality of multi-component commands; and
in accordance with a determination that the received input component is the last component in the multi-component command, executing the multi-component command.

9. A server system comprising:
one or more processors configured to include:
a list storage module to store a list of reference commands in memory of the server system, wherein a reference command is a command with an associated gesture that a user can execute without display of a radial menu;
an input analysis module to receive a first input component from a user;
a matching module to determine whether the first input component matches a first component of at least one reference command in the list of reference commands;
a command reception module to, in accordance with a determination that the first input component matches the first component of the at least one reference command in the list of reference commands, continue to monitor user input without displaying a radial menu; and
a radial menu module to, in accordance with a determination that the first input component does not match the first component of the at least one reference command in the list of reference commands, display the radial menu to the user.

10. The server system of claim 9, further comprising
a generation module to generate the list of reference commands.

11. The server system of claim 10, wherein further comprising, to generate the list of reference commands:
a reception module to receive a command input with one or more components;
a pause detection module to determine whether the command input is received within a predetermined time window; and
an addition module to, in accordance with a determination that the command input is received within the predetermined time window, add a command associated with the command input to the list of reference commands.

12. The server system of claim 9, wherein each reference command in the list of reference commands includes one or more components.

13. The server system of claim 9, further comprising:
a reception module to, prior to receiving the first input component, receive a command initiation input.

14. The server system of claim 9, wherein the input component is finger gestures on a touch screen display.

15. A non-transitory computer-readable storage medium storing instructions that, when executed by the one or more processors of a machine, cause the machine to perform operations comprising:
storing a list of reference commands, wherein a reference command is a command with an associated gesture that a user can execute without display of a radial menu;
receiving a first input component from a user;
determining whether the first input component matches a first component of at least one reference command in the list of reference commands;
in accordance with a determination that the first input component matches the first component of the at least one reference command in the list of reference commands, continuing to monitor user input without displaying a radial menu; and
in accordance with a determination that the first input component does not match the first component of the at least one reference command in the list of reference commands, displaying the radial menu to the user.

16. The non-transitory computer-readable storage medium of claim 15, further comprising generating the list of reference commands.

17. The non-transitory computer-readable storage medium of claim 16, wherein generating the list of reference commands comprises:
receiving a command input with one or more components;
determining whether the command input is received within a predetermined time window; and
in accordance with a determination that the command input is received within the predetermined time window, adding a command associated with the command input to the list of reference commands.

18. The non-transitory computer-readable storage medium of claim 15, wherein each reference command in the list of reference commands includes one or more components.

19. The non-transitory computer-readable storage medium of claim 15, further comprising, prior to receiving the first input component, receiving a command initiation input.

20. The non-transitory computer-readable storage medium of claim 15, wherein the input component is finger gestures on a touch screen display.
